(19) United States
(12) Patent Application Publication
(10) Pub. No.: US 2006/0177296 A1
(43) Pub. Date: Aug. 10, 2006

(54) Transfer devices and methods for handling microfeature workpieces within an environment of a processing machine

(75) Inventor: Paul Wirth, Columbia Falls, MT (US)

Correspondence Address: PERKINS COIE LLP, P.O. BOX 1247, PATENT-SEA, SEATTLE, WA, 98111-1247, US

(73) Assignee: Semitool, Inc.

(21) Appl. No.: 11/054,872

(22) Filed: Feb. 9, 2005

(51) Int. Cl. B66C 23/00

(52) U.S. Cl. 414/744.5

(57) ABSTRACT

Transfer devices and methods for handling microfeature workpieces are disclosed herein. In one embodiment, a transfer device includes a base unit, a first arm pivotably coupled to the base unit and rotatable about a first axis, a second arm pivotably coupled to the first arm and rotatable over 360 degrees about a second axis, and an end-effector pivotably coupled to the second arm and rotatable over 360 degrees about a third axis. The first axis is generally parallel to and spaced apart from the second axis, and the second axis is generally parallel to and spaced apart from the third axis. The end-effector can rotate about the third axis independent of the rotation of the second arm about the second axis.

### TECHNICAL FIELD

The present invention relates to equipment for handling microfeature workpieces. More particularly, the present invention is directed to transfer devices for handling microfeature workpieces within an environment of a processing machine.

### BACKGROUND

Microelectronic devices are fabricated on and/or in microelectronic workpieces using several different apparatus (“tools”). Many such processing apparatus have a single processing station that performs one or more procedures on the workpieces. Other processing apparatus have a plurality of processing stations that perform a series of different procedures on individual workpieces or batches of workpieces. The workpieces are often handled by automatic handling equipment (i.e., robots) because microelectronic fabrication requires very precise positioning of the workpieces and/or conditions that are not suitable for human access (e.g., vacuum environments, high temperatures, chemicals, stringent clean standards, etc.).

An increasingly important category of processing apparatus is plating tools that plate metals and other materials onto workpieces. Existing plating tools use automatic handling equipment to handle the workpieces because the position, movement, and cleanliness of the workpieces are important parameters for accurately plating materials onto the workpieces. The plating tools can be used to plate metals and other materials (e.g., ceramics or polymers) in the formation of contacts, interconnects, and other components of microelectronic devices. For example, copper plating tools are used to form copper contacts and interconnects on semiconductor wafers, field emission displays, read/write heads, and other types of microelectronic workpieces. A typical copper plating process involves depositing a copper seed layer onto the surface of the workpiece using chemical vapor deposition (CVD), physical vapor deposition (PVD), electroless plating processes, or other suitable methods. After forming the seed layer, copper is plated onto the workpiece by applying an appropriate electrical field between the seed layer and an anode in the presence of an electrochemical plating solution. The workpiece is then cleaned, etched, and/or annealed in subsequent procedures before transferring the workpiece to another apparatus.

Single-wafer plating tools generally have a load/unload station, a number of processing chambers (e.g., plating and/or cleaning chambers), and a transfer mechanism for moving the workpieces between the chambers and the load/unload station. The transfer mechanism can be a rotary system having one or more robots that rotate about a fixed location in the plating tool. Alternate transfer mechanisms include linear systems that have an elongated track and a robot that moves along the track. Many rotary and linear transfer mechanisms have a plurality of individual robots that can each independently access most, if not all, of the processing chambers within an individual tool to increase the flexibility and throughput of the plating tool.

The robots also include one or more arms that project laterally from the robot and one or more end-effectors coupled to the arms for carrying the workpieces from one processing station to another. For example, U.S. Pat. No. 5,765,444 discloses a robot having a torso, two arm assemblies attached to the torso, and two end-effectors attached to corresponding arm assemblies. The individual arm assemblies include a first arm attached to the torso, a second arm attached to the first arm, and an end-effector attached to the second arm. The robot also includes (a) a first motor for pivoting the first arm about a first axis, and (b) a second motor for pivoting the second arm about a second axis and the end-effector about a third axis. The end-effector is coupled to the second arm such that the second motor drives both the second arm and the end-effector together. The end-effector accordingly rotates in direct proportion to rotation of the second arm. This limits the mobility of the robot, which restricts the locations that the end-effector can access and the tasks that the robot can perform.

To address this concern, conventional robots have been developed that include a first arm, a second arm pivotably attached to the first arm, an end-effector pivotably attached to the second arm, and a motor at the distal end of the second arm to rotate the end-effector relative to the second arm. Although the end-effector pivots independent of the second arm, these robots have several drawbacks that decrease the throughput of the tool. First, the robots typically have hard stops that prevent the end-effector from rotating over 360 degrees. The hard stops accordingly limit the mobility of the robots, which increases the time required to perform certain tasks. Second, the weight of the motor at the distal end of the second arm slows the movement of the robots. Third, to provide power to the motor, the robots include electric or hydraulic rotary couplings between the arms that are expensive and may require extensive maintenance to prevent failure. Accordingly, there is a need to improve transfer devices to increase the mobility of the robot and the throughput of the tool.

### SUMMARY

The present invention is directed to transfer devices having end-effectors that rotate independently of the movement of the arm or link to which the end-effector is attached. This enhances the flexibility of operating the transfer device because the end-effector is able to move (a) without moving the arm, (b) to a different extent than the arm, and/or (c) in a different direction than the arm. Such enhanced flexibility allows the transfer device to accurately position workpieces without having to move the transfer device along a track or about a rotating base. As a result, the transfer device is able to handle a large number of wafer operations in a given period of time to increase the efficiency and reduce the operating cost of the tool.

The present invention is also directed to transfer devices having end-effectors that rotate 360 degrees or more in either direction. This further enhances the flexibility and efficiency of the transfer device because the end-effector is able to rotate directly to a desired position along the shortest rotational arc.

The transfer devices include a base unit, a first arm pivotably coupled to the base unit, a second arm pivotably coupled to the first arm, and an end-effector pivotably coupled to the second arm. The first and second arms and the end-effector are each independently rotatable over 360 degrees about different axes. As such, the transfer device performs certain tasks very quickly to enhance the throughput of the tool as explained above.

The transfer devices further include a first motor carried by the base unit for pivoting the first arm about the first axis, a second motor carried by the base unit and/or the first arm for pivoting the second arm about the second axis, and a third motor carried by the base unit and/or the first arm for pivoting the end-effector about the third axis. Accordingly, the second arm does not carry the motor that drives the end-effector about the third axis, which advantageously reduces the weight in the second arm. As a result, the device moves more quickly to further enhance the throughput of the tool.

The transfer devices accordingly have greater flexibility and mobility than (a) devices having a single arm connecting the end-effector to the base, (b) devices having multiple arms but one arm and the end-effector are not independently pivotable, and (c) devices having multiple arms with the arms and end-effector independently pivotable but unable to rotate over 360 degrees. The additional mobility allows the transfer devices to move the end-effector to locations in the cabinet that would otherwise be inaccessible or would require the device to move linearly along the track. Thus, the flexibility and mobility of the transfer devices reduce the time required to perform certain tasks to increase the throughput of the tool and lower the operating cost of the tool.

Another aspect of the invention is directed toward transfer devices with a belt tensioning mechanism that significantly improves the life of the drive belt for the end-effector. The tensioning mechanism is positioned inside the belt and exerts forces on the belt in opposing directions. The opposing forces are generally symmetrical. As a result, the belt has a longer life because it is not subjected to asymmetrical loading that creates uneven wear.

### BRIEF DESCRIPTION OF THE DRAWINGS

FIG. 1 is an isometric view of an apparatus for processing microfeature workpieces including a transfer device for handling the workpieces in accordance with an embodiment of the invention. A portion of the processing apparatus is shown in a cutaway illustration.

FIG. 2 is an isometric view of a transfer device for handling microfeature workpieces in accordance with one embodiment of the invention.

FIG. 3 is a side view of the transfer device of FIG. 2.

FIG. 4 is a schematic side cross-sectional view of an arm assembly of the transfer device in accordance with one embodiment of the invention.

FIG. 5 is a schematic side cross-sectional view of the arm assembly taken substantially along the line 5-5 of FIG. 4.

FIG. 6 is a schematic side cross-sectional view of the arm assembly taken substantially along the line 6-6 of FIG. 4.

FIG. 7 is a schematic side cross-sectional view of a distal end portion of a second arm of the arm assembly of FIG. 4.

FIG. 8 is a top plan view of first and second arms of the arm assembly of FIG. 4 with a cover of the second arm removed.

### DETAILED DESCRIPTION

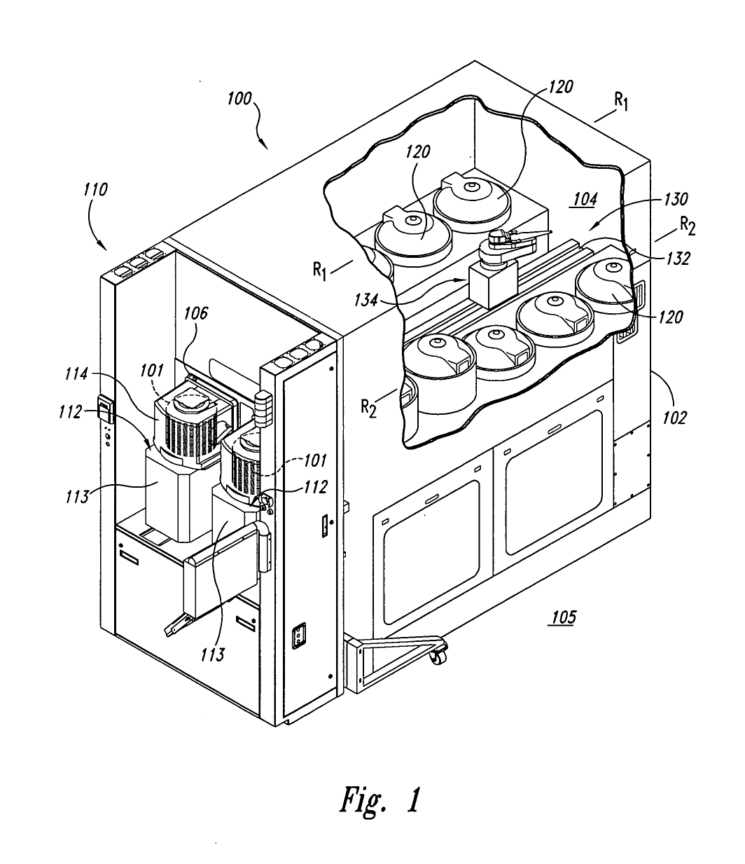

The following description discloses the details and features of several embodiments of transfer devices with end-effectors for handling microfeature workpieces and methods for using such devices. The terms “microfeature workpiece” or “workpiece” refer to substrates on and/or in which microdevices are formed. Typical microdevices include microelectronic circuits or components, thin-film recording heads, data storage elements, microfluidic devices, and other products. Micromachines or micromechanical devices are included within this definition because they are manufactured in much the same manner as integrated circuits. The substrates are generally semiconductive pieces (e.g., silicon wafers or gallium arsenide wafers), nonconductive pieces (e.g., various ceramic substrates), or conductive pieces (e.g., doped wafers). It will be appreciated that several of the details set forth below are provided to describe the following embodiments in a manner sufficient to enable a person skilled in the art to make and use the disclosed embodiments. Many of the details and advantages described below, however, may not be necessary to practice certain embodiments of the invention. Moreover, additional embodiments within the scope of the claims are not necessarily described in detail with respect to FIGS. 1-8.

A. Embodiments of Microfeature Workpiece Processing Machines for Use With Automatic Workpiece Transfer Devices

FIG. 1 is an isometric view of a processing apparatus 100 having a transfer device 130 for manipulating a plurality of microfeature workpieces 101 in accordance with an embodiment of the invention. A portion of the processing apparatus 100 is shown in a cutaway view to illustrate selected internal components. The processing apparatus 100 includes a cabinet 102 having an interior region 104 defining an enclosure that is at least partially isolated from an exterior region 105. The illustrated cabinet 102 also includes a plurality of apertures 106 through which the workpieces 101 can ingress and egress between the interior region 104 and a load/unload station 110.

The load/unload station 110 has container supports 112 each housed in a protective shroud 113. The container supports 112 are configured to position workpiece containers 114 relative to the apertures 106 in the cabinet 102. The workpiece containers 114 each house a plurality of microfeature workpieces 101 in a “mini” clean environment for carrying the workpieces 101 through other environments that are not at clean room standards. Each of the workpiece containers 114 is accessible from the interior region 104 of the cabinet 102 through the apertures 106. The load/unload station 110 shown in FIG. 1 has two containers 114, but the load/unload station 110 can have three or more containers 114 in other embodiments.

The processing apparatus 100 further includes a plurality of processing stations 120 and the transfer device 130 in the interior region 104 of the cabinet 102. The processing apparatus 100, for example, can be a plating tool, and the processing stations 120 can be single-wafer chambers for electroplating, electroless plating, annealing, cleaning, etching, and/or metrology analysis. Suitable processing stations 120 for use in the processing apparatus 100 are disclosed in U.S. Pat. Nos. 6,780,374; 6,660,137; 6,569,297; 6,471,913; 6,309,524; 6,309,520; 6,303,010; 6,280,583; 6,228,232; and 6,080,691, and in U.S. patent application Ser. Nos. 10/861,899 and 10/729,349, all of which are incorporated by reference herein. The processing stations 120 are not limited to plating devices, and thus the processing apparatus 100 can be another type of tool.

The transfer device 130 moves the microfeature workpieces 101 between the workpiece containers 114 and the processing stations 120. The illustrated transfer device 130 includes a linear track 132 extending in a lengthwise direction between a first set of processing stations 120 arranged along a first row R₁-R₁ and a second set of processing stations 120 arranged along a second row R₂-R₂. In other embodiments, the two or more processing stations 120 are arranged in a single row on one side of the track 132. The transfer device 130 further includes a robot unit 134 carried by the track 132.

B. Embodiments of Transfer Devices for Handling Microfeature Workpieces in Processing Machines

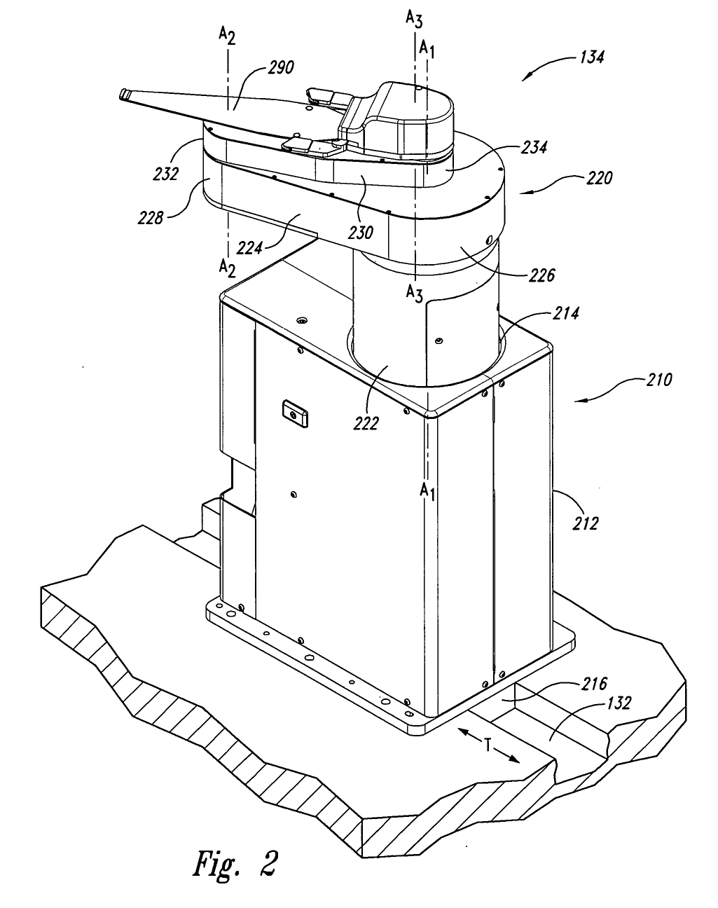

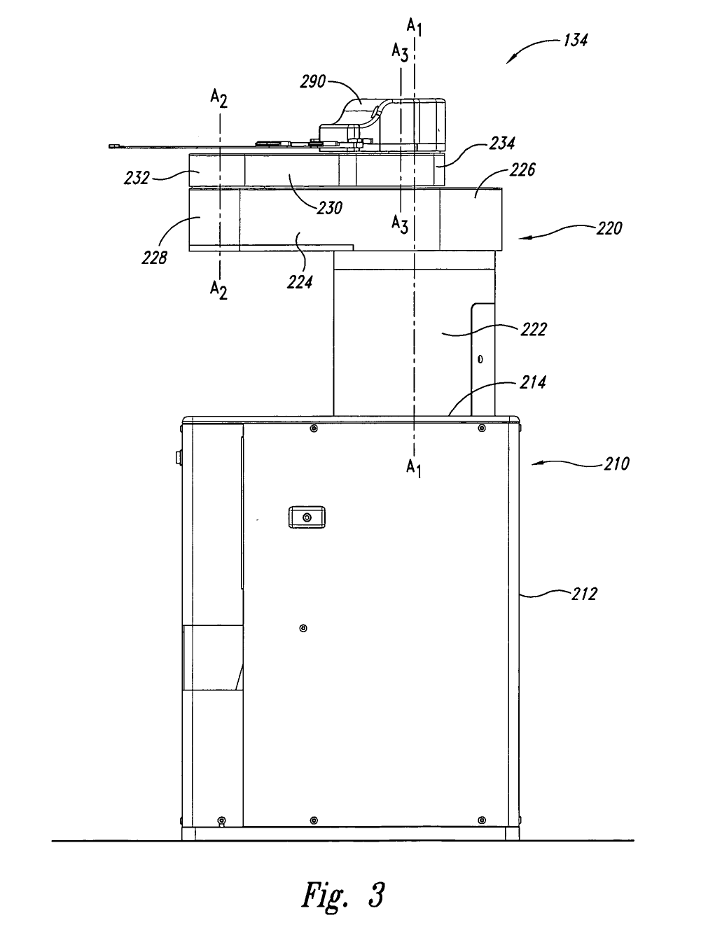

FIG. 2 is an isometric view and FIG. 3 is a side view of an embodiment of the robot unit 134 in greater detail. Referring to both FIGS. 2 and 3, the illustrated robot unit 134 includes a transport unit 210, an arm assembly 220 carried by the transport unit 210, and an end-effector 290 carried by the arm assembly 220. The embodiment of the transport unit 210 shown in FIGS. 2 and 3 includes a shroud or housing 212 having a plurality of panels attached to an internal frame (not shown). A top panel of the housing 212 includes an opening 214 for receiving a portion of the arm assembly 220. The transport unit 210 also includes a guide member configured to move laterally along the track 132 (FIG. 2). In the particular embodiment of the transport unit 210 shown in FIG. 2, the guide member is a base plate 216 (FIG. 2) that slidably couples the robot unit 134 to the track 132. The robot unit 134 accordingly translates along the track 132 (arrow T) to position the robot unit 134 adjacent to a desired processing station 120 (FIG. 1). It will be appreciated that the transport unit 210 and the housing 212 can have configurations different than the embodiment shown in FIGS. 2 and 3 depending upon the particular environment in which the robot unit 134 is used. In one such alternative embodiment, the transport unit 210 has a base that is stationary, rotary, or moves in a nonlinear manner.

The illustrated arm assembly 220 includes a first arm 224 pivotably coupled to the transport unit 210 and a second arm 230 pivotably coupled to the first arm 224. The specific first arm 224 shown in FIGS. 2 and 3 has a waist member 222 projecting toward the transport unit 210, a proximal end portion 226 adjacent to the waist member 222, and a distal end portion 228 opposite the proximal end portion 226. The first arm 224 has a fixed length, and the waist member 222 is rotably coupled to the transport unit 210 so that the first arm 224 rotates about a first axis A₁-A₁. The second arm 230 includes a proximal end portion 232 attached to the distal end portion 228 of the first arm 224 and a distal end portion 234 opposite the proximal end portion 232. The second arm 230 has a fixed length and is pivotably coupled to the first arm 224 so that the second arm 230 rotates about a second axis A₂-A₂. The second axis A₂-A₂ is spaced apart from and generally parallel to the first axis A₁-A₁.

The end-effector 290 is pivotably coupled to the distal end portion 234 of the second arm 230 and rotatable about a third axis A₃-A₃. The third axis A₃-A₃ illustrated in FIGS. 2 and 3 is generally parallel to and spaced apart from the second axis A₂-A₂. The third axis A₃-A₃, however, is not limited to this orientation and can be transverse to the second axis A₂-A₂. The end-effector 290 is configured to selectively grasp and secure a workpiece while the robot unit 134 moves the workpiece. Suitable end-effectors are disclosed in U.S. Pat. Nos. 6,752,584; 6,749,391; and 6,749,390, and U.S. patent application Ser. Nos. 10/873,568; 10/620,326; 10/195,137; 10/194,939; and 60/586,514, all of which are incorporated by reference herein.

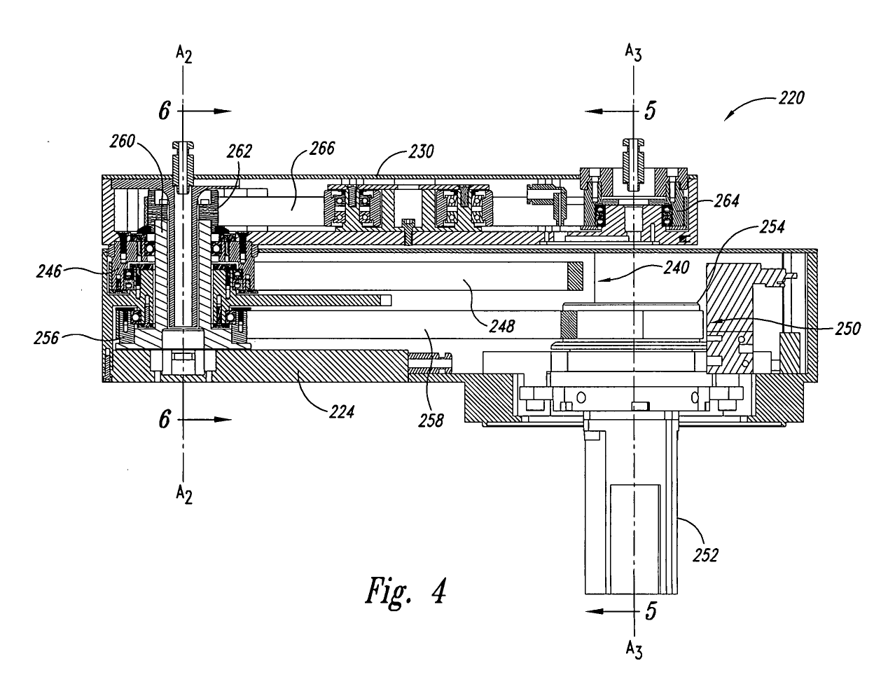

The robot unit 134 further includes a plurality of drive assemblies (described in detail below with reference to FIGS. 4-7) for moving the first arm 224 about the first axis A₁-A₁, the second arm 230 about the second axis A₂-A₂, and the end-effector 290 about the third axis A₃-A₃. In many applications, the robot unit 134 also includes a lift assembly (not shown) for moving the arm assembly 220 linearly along the first axis A₁-A₁ to change the elevation of the first and second arms 224 and 230 and position the end-effector 290 at a desired elevation, but in other embodiments the arm assembly 220 may be at a fixed elevation. The drive assemblies and the lift assembly move the first arm 224, the second arm 230, and/or the end-effector 290 to position the end-effector 290 proximate to a desired workpiece container 114 (FIG. 1) or processing station 120 (FIG. 1).

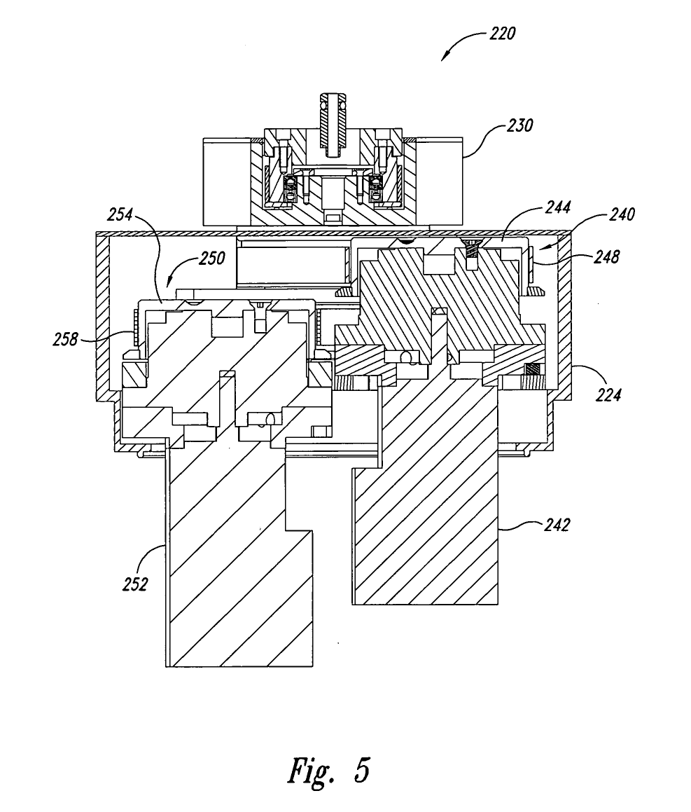

FIG. 4 is a schematic side cross-sectional view illustrating the drive assemblies of the arm assembly 220 in accordance with one embodiment of the invention. FIG. 5 is a schematic side cross-sectional view of the arm assembly 220 taken substantially along the line 5-5 of FIG. 4. Referring to both FIGS. 4 and 5, the arm assembly 220 includes a first drive assembly 240 for rotating the second arm 230 about the second axis A₂-A₂ (FIG. 4) and a second drive assembly 250 for rotating the end-effector 290 (FIG. 3) about the third axis A₃-A₃ (FIG. 4). The first and second drive assemblies 240 and 250 are separate and independent mechanisms such that the first drive assembly 240 can pivot the second arm 230 about the second axis A₂-A₂ whether or not the end-effector 290 is rotating about the third axis A₃-A₃. Similarly, the second drive assembly 250 can pivot the end-effector 290 about the third axis A₃-A₃ whether or not the second arm 230 is rotating about the second axis A₂-A₂. As a result, the second arm 230 and the end-effector 290 operate independently of each other.

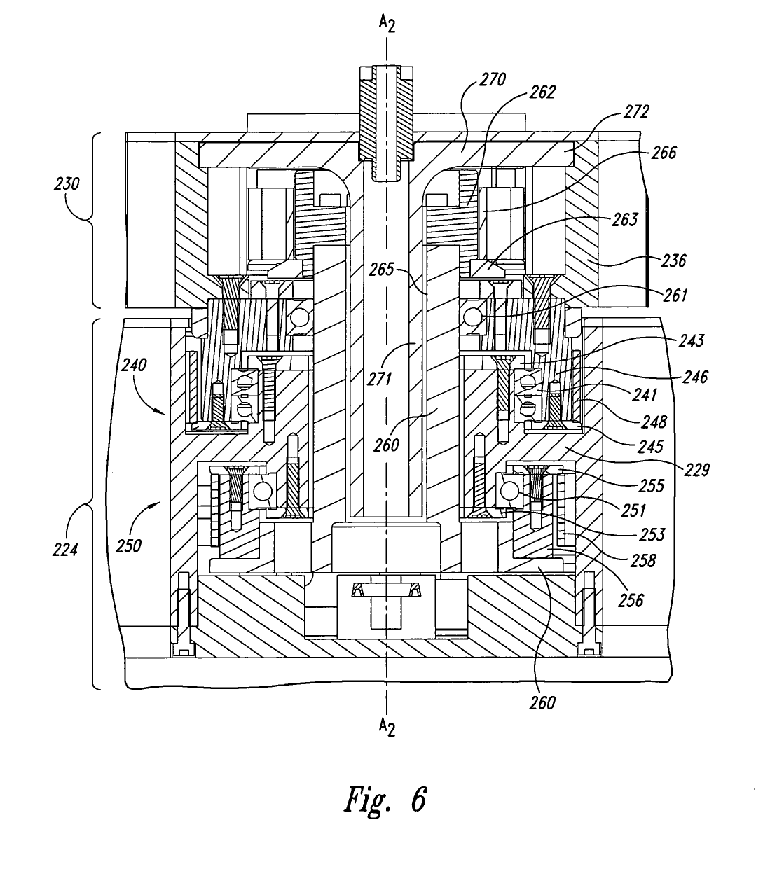

The illustrated first drive assembly 240 includes a first motor 242 (FIG. 5), a first pulley 244 (FIG. 5) attached to the first motor 242, a second pulley 246 (FIG. 4), and a first belt 248 for transmitting motion from the first pulley 244 to the second pulley 246. The second pulley 246 is operably coupled to the second arm 230 so that the second pulley 246 and the second arm 230 pivot about the second axis A₂-A₂ together, as described in greater detail below with reference to FIG. 6.

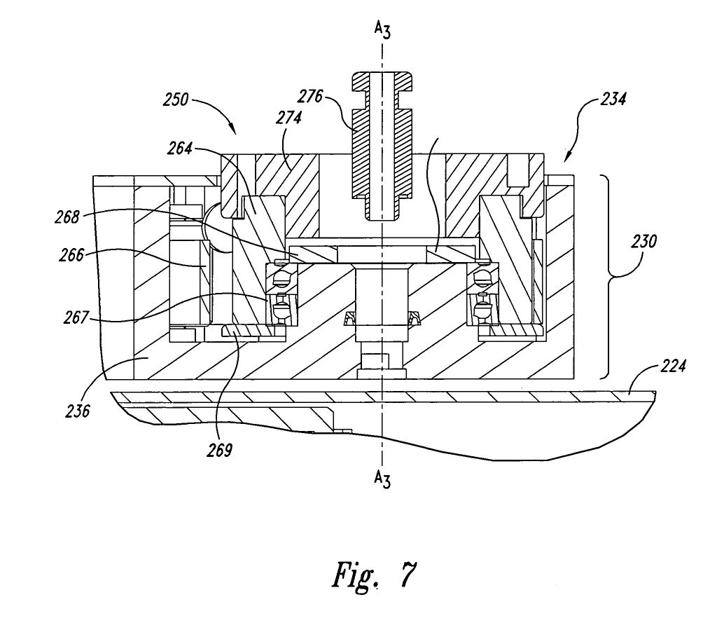

The illustrated second drive assembly 250 includes a second motor 252, a third pulley 254 attached to the second motor 252, a fourth pulley 256 (FIG. 4), and a second belt 258 for transmitting motion from the third pulley 254 to the fourth pulley 256. Referring only to FIG. 4, the illustrated second drive assembly 250 further includes a drive shaft 260 attached to the fourth pulley 256, a fifth pulley 262 attached to the drive shaft 260, a sixth pulley 264, and a third belt 266 for transmitting motion from the fifth pulley 262 to the sixth pulley 264. The sixth pulley 264 is operably coupled to the end-effector 290 so that the sixth pulley 264 and the end-effector 290 pivot about the third axis A₃-A₃ together, as described in greater detail below with reference to FIG. 7.

FIG. 6 is an enlarged schematic side cross-sectional view of the arm assembly 220 taken substantially along the line 6-6 of FIG. 4. The first drive assembly 240 further includes an annular bearing 241 and a clamp 243 attached to the bearing 241. The bearing 241 is positioned between the second pulley 246 and an interior member 229 of the first arm 224 so that the second pulley 246 can rotate about the second axis A₂-A₂. The bearing clamp 243 is attached to the interior member 229 to secure a stationary portion of the bearing 241 to the first arm 224. The second pulley 246 is attached to the rotating portion of the bearing 241 with a clamp 245 and to an interior member 236 of the second arm 230 so that the second arm 230 pivots about the second axis A₂-A₂ as the first belt 248 drives the second pulley 246.

The second drive assembly 250 further includes an annular bearing 251 and a clamp 253 attached to a fixed portion of the bearing 251. The bearing 251 is positioned between the fourth pulley 256 and the interior member 229 of the first arm 224 so that the fourth pulley 256 can rotate about the second axis A₂-A₂. The bearing clamp 253 is attached to the interior member 229 to secure a stationary portion of the bearing 251 to the first arm 224. The fourth pulley 256 is attached to the rotating portion of the bearing 251 with a clamp 255. The fourth pulley 256 is also attached to the drive shaft 260, which is in turn coupled to the fifth pulley 262 so that the fifth pulley 262 pivots about the second axis A₂-A₂ with the fourth pulley 256. The fifth pulley 262 includes a flange 263 to retain the third belt 266 on the pulley 262. Accordingly, as the second motor 252 (FIG. 4) drives the second belt 258, the fifth pulley 262 drives the third belt 266.

The second drive assembly 250 further includes an annular bearing 261 attached to the second pulley 246 for providing axial support to a cylindrical portion of the drive shaft 260. Moreover, the second drive assembly 250 also includes a stabilizing shaft 270 having a cylindrical portion 271 received within a bore 265 of the drive shaft 260 and a flange 272 attached to the interior member 236 of the second arm 230. The stabilizing shaft 270 also provides axial stability to the drive shaft 260.

FIG. 7 is an enlarged schematic side cross-sectional view of the distal end portion 234 of the second arm 230. The second drive assembly 250 further includes an annular bearing 267 and a clamp 268 attached to the bearing 267. The bearing 267 is positioned between the sixth pulley 264 and the interior member 236 of the second arm 230 so that the sixth pulley 264 can rotate about the third axis A₃-A₃. The bearing clamp 268 is attached to the interior member 236 to secure a stationary portion of the bearing 267 to the second arm 230. The sixth pulley 264 is attached to the rotating portion of the bearing 267 with a clamp 269. The sixth pulley 264 is also attached to a driver 274 having a shaft 276, which is coupled to the end-effector 290 (FIG. 2) so that the end-effector 290 pivots about the third axis A₃-A₃ with the sixth pulley 264. Accordingly, as the second motor 252 (FIG. 4) drives the second belt 258, the shaft 276 drives the end-effector 290 about the third axis A₃-A₃. In additional embodiments, the first and second drive assemblies 240 and 250 can have other suitable configurations to rotate the second arm 230 about the second axis A₂-A₂ and the end-effector 290 about the third axis A₃-A₃, respectively.

One feature of the robot unit 134 illustrated in FIGS. 1-7 is that the first arm 224, second arm 230, and end-effector 290 are independently rotatable about different axes. As such, the second arm 230 can pivot about the second axis A₂-A₂ independent of the rotation of the first arm 224 about the first axis A₁-A₁, and the end-effector 290 can pivot about the third axis A₃-A₃ independent of the rotation of the first and second arms 224 and 230 about their respective axes. Another feature of the robot unit 134 illustrated in FIGS. 1-7 is that the first drive assembly 240 can rotate the second arm 230 over 360 degrees about the second axis A₂-A₂ and the second drive assembly 250 can rotate the end-effector 290 over 360 degrees about the third axis A₃-A₃. An advantage of these features is that the illustrated robot unit 134 has greater flexibility and mobility than (a) a robot having a single arm connecting the end-effector to the base, (b) a robot having multiple arms but the arms and end-effector are not independently pivotable, and (c) a robot having multiple arms with the arms and end-effector independently pivotable but unable to rotate over 360 degrees. Accordingly, the illustrated robot unit 134 can move the end-effector 290 to locations in the cabinet 102 that would be otherwise inaccessible or require the robot unit 134 to move along the track 132. Thus, the flexibility and mobility of the robot unit 134 reduce the time required to perform certain tasks and increase the throughput of the tool.

Another feature of the robot unit 134 illustrated in FIGS. 1-7 is that the first and second motors 242 and 252 are carried by the first arm 224 in and/or over the waist member 222. An advantage of this feature is that the position of the first and second motors 242 and 252 in and/or over the waist member 222 increases the speed at which the robot unit 134 can operate because the weight of these motors 242 and 252 is not carried by the distal end portion 228 of the first arm 224 or the second arm 230. By contrast, in several conventional robots, the motor that drives the end-effector is positioned in the second arm, which increases the weight in the second arm and slows the movement of the robot.

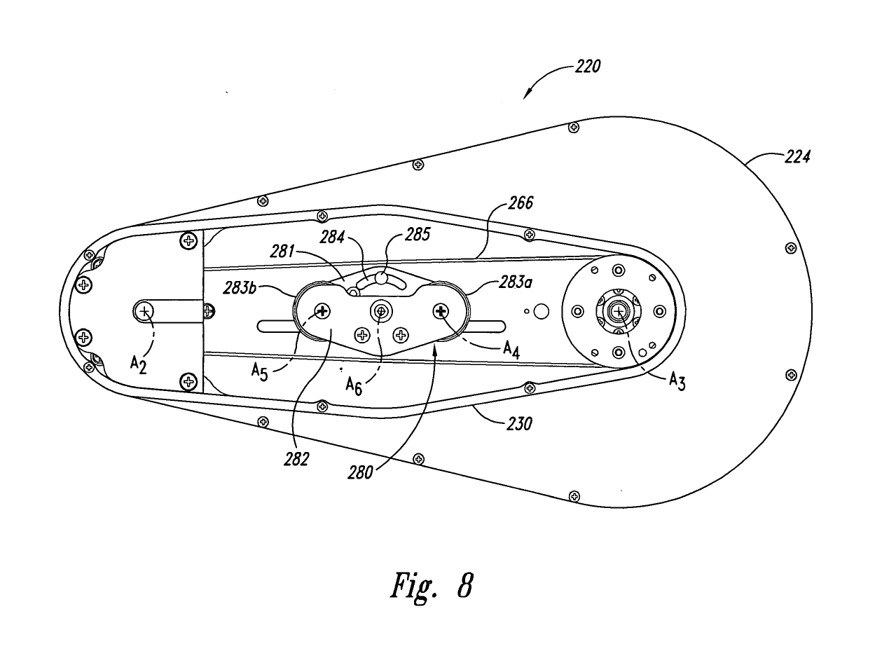

FIG. 8 is a top plan view of the first and second arms 224 and 230 with a cover of the second arm 230 removed. The illustrated arm assembly 220 further includes a tensioning mechanism 280 for selectively adjusting the tension in the third belt 266. The embodiment of the tensioning mechanism 280 shown in FIG. 8 includes a mounting plate 281 pivotably attached to the second arm 230, a top plate 282 spaced apart from the mounting plate 281, and seventh and eighth pulleys 283a-b positioned between the mounting and top plates 281 and 282. The seventh pulley 283a is freely rotatable about a fourth axis A₄, and the eighth pulley 283b is freely rotatable about a fifth axis A₅ spaced apart from the fourth axis A₄. The tensioning mechanism 280 is selectively pivotable about a sixth axis A₆ so that the seventh and eighth pulleys 283a-b can each exert a desired force on a different side of the third belt 266 to adjust the tension in the belt 266. To maintain the desired tension in the third belt 266, the tensioning mechanism 280 is locked into place with a set screw 285 received in a slot 284 of the mounting plate 281. In other embodiments, the arm assembly 220 may not include the tensioning mechanism 280, or the tensioning mechanism 280 may have different configurations.

One feature of the tensioning mechanism 280 illustrated in FIG. 8 is that the seventh and eighth pulleys 283a-b exert radially outward forces on opposite sides of the third belt 266. An advantage of this feature is that the third belt 266 has a longer life because the belt 266 is not subjected to asymmetrical loading that creates uneven wear. By contrast, in conventional systems, the tensioning mechanism presses a roller against one side of the belt, which creates uneven wear in the belt.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/we claim:

1. A transfer device for handling microfeature workpieces within an environment of a processing machine, the transfer device comprising:
a base unit;
a first arm coupled to the base unit and pivotable about a first axis;
a second arm pivotably coupled to the first arm and rotatable over 360 degrees about a second axis generally parallel to the first axis and spaced apart from the first axis; and
an end-effector pivotably coupled to the second arm and rotatable over 360 degrees about a third axis generally parallel to the second axis and spaced apart from the second axis, wherein the end-effector can rotate about the third axis independent of the rotation of the second arm about the second axis.

2. The transfer device of claim 1, further comprising a motor carried by the base unit and/or the first arm for rotating the end-effector about the third axis.

3. The transfer device of claim 1, further comprising:
a first motor carried by the base unit, the first motor operably coupled to the first arm for pivoting the first arm about the first axis;
a second motor carried by the base unit and/or the first arm, the second motor operably coupled to the second arm for pivoting the second arm about the second axis; and
a third motor carried by the base unit and/or the first arm, the third motor operably coupled to the end-effector for rotating the end-effector about the third axis.

4. The transfer device of claim 1 wherein the end-effector can rotate about the third axis without being driven by a motor in the second arm.

5. The transfer device of claim 1, further comprising:
a first drive assembly for rotating the second arm about the second axis, the first drive assembly including a first motor in the base unit and/or the first arm, a first pulley in the first arm and operably coupled to the second arm, and a first belt for transmitting motion from the first motor to the first pulley; and
a second drive assembly for rotating the end-effector about the third axis, the second drive assembly including a second motor in the base unit and/or the first arm, a second pulley in the first arm, a shaft attached to the second pulley, a second belt for transmitting motion from the second motor to the second pulley and the shaft, a third pulley in the second arm and attached to the shaft, a fourth pulley in the second arm and operably coupled to the end-effector, and a third belt for transmitting motion from the third pulley to the fourth pulley and the end-effector.

6. The transfer device of claim 1, further comprising:
a drive assembly for rotating the end-effector about the third axis, the drive assembly including a motor in the base unit and/or the first arm, a first pulley in the first arm, a shaft attached to the first pulley, a first belt for transmitting motion from the motor to the first pulley and the shaft, a second pulley in the second arm and attached to the shaft, a third pulley in the second arm and operably coupled to the end-effector, and a second belt for transmitting motion from the second pulley to the third pulley and the end-effector; and
a tensioning mechanism for adjusting the tension in the second belt.

7. The transfer device of claim 1 wherein:
the first arm has a proximal end portion coupled to the base unit and a distal end portion spaced apart from the proximal end portion;
the second arm has a proximal end portion coupled to the first arm and a distal end portion spaced apart from the proximal end portion; and
the end-effector has a proximal end portion coupled to the second arm.

8. A transfer device for handling microfeature workpieces within an environment of a processing machine, the transfer device comprising:
a base unit;
an arm assembly carried by the base unit, the arm assembly including a first arm attached to the base unit and a second arm attached to the first arm, the first arm being rotatable about a first axis and the second arm being rotatable about a second axis spaced apart from the first axis; and
an end-effector attached to the second arm and rotatable about a third axis spaced apart from the second axis, wherein the end-effector can rotate about the third axis independent of the rotation of the second arm about the second axis and without being driven by a motor in the second arm.

9. The transfer device of claim 8, further comprising:
a first motor carried by the base unit, the first motor operably coupled to the first arm for pivoting the first arm about the first axis;
a second motor carried by the base unit and/or the first arm, the second motor operably coupled to the second arm for pivoting the second arm about the second axis; and
a third motor carried by the base unit and/or the first arm, the third motor operably coupled to the end-effector for rotating the end-effector about the third axis.

10. The transfer device of claim 8, further comprising a motor carried by the base unit and/or the first arm for rotating the end-effector about the third axis.

11. The transfer device of claim 8 wherein:
the second arm is rotatable over 360 degrees about the second axis; and
the end-effector is rotatable over 360 degrees about the third axis.

12. The transfer device of claim 8, further comprising:
a first drive assembly for rotating the second arm about the second axis, the first drive assembly including a first motor in the base unit and/or the first arm, a first pulley in the first arm and operably coupled to the second arm, and a first belt for transmitting motion from the first motor to the first pulley; and
a second drive assembly for rotating the end-effector about the third axis, the second drive assembly including a second motor in the base unit and/or the first arm, a second pulley in the first arm, a shaft attached to the second pulley, a second belt for transmitting motion from the second motor to the second pulley and the shaft, a third pulley in the second arm and attached to the shaft, a fourth pulley in the second arm and operably coupled to the end-effector, and a third belt for transmitting motion from the third pulley to the fourth pulley and the end-effector.

13. The transfer device of claim 8, further comprising:
a drive assembly for rotating the end-effector about the third axis, the drive assembly including a motor in the base unit and/or the first arm, a first pulley in the first arm, a shaft attached to the first pulley, a first belt for transmitting motion from the motor to the first pulley and the shaft, a second pulley in the second arm and attached to the shaft, a third pulley in the second arm and operably coupled to the end-effector, and a second belt for transmitting motion from the second pulley to the third pulley and the end-effector; and
a tensioning mechanism carried by the second arm for adjusting the tension in the second belt.

14. A transfer device for handling microfeature workpieces within an environment of a processing machine, the transfer device comprising:
a base unit;
a first arm coupled to the base unit and pivotable about a first axis;
a second arm pivotably coupled to the first arm and rotatable over 360 degrees about a second axis along the first arm spaced apart from the first axis;
an end-effector pivotably coupled to the second arm and rotatable over 360 degrees about a third axis along the second arm spaced apart from the second axis; and
means for rotating the end-effector about the third axis without rotating the second arm about the second axis.

15. The transfer device of claim 14 wherein the means for rotating the end-effector comprise a motor carried by the base unit and/or the first arm, the motor being operably coupled to the end-effector for rotating the end-effector about the third axis.

16. The transfer device of claim 14 wherein the means for rotating the end-effector comprise a drive assembly including a motor in the base unit and/or the first arm, a first pulley in the first arm, a shaft attached to the first pulley, a first belt for transmitting motion from the motor to the first pulley and the shaft, a second pulley in the second arm and attached to the shaft, a third pulley in the second arm and operably coupled to the end-effector, and a second belt for transmitting motion from the second pulley to the third pulley and the end-effector.

17. The transfer device of claim 14 wherein:
the means for rotating the end-effector comprise a drive assembly including a motor in the base unit and/or the first arm, a first pulley in the first arm, a shaft attached to the first pulley, a first belt for transmitting motion from the motor to the first pulley and the shaft, a second pulley in the second arm and attached to the shaft, a third pulley in the second arm and operably coupled to the end-effector, and a second belt for transmitting motion from the second pulley to the third pulley and the end-effector; and
the transfer device further comprises a tensioning mechanism carried by the second arm for adjusting the tension in the second belt.

18. The transfer device of claim 14 wherein:
the means for rotating the end-effector comprise a first motor carried by the base unit and/or the first arm, the first motor being operably coupled to the end-effector for rotating the end-effector about the third axis; and
the transfer device further comprises a second motor carried by the base unit and/or the first arm, the second motor operably coupled to the second arm for pivoting the second arm about the second axis.

19. A transfer device for handling microfeature workpieces within an environment of a processing machine, the transfer device comprising:
a base unit;
an arm assembly carried by the base unit, the arm assembly including a first arm rotatably coupled to the base unit and a second arm rotatably coupled to the first arm;
a first motor carried by the base unit, the first motor operably coupled to the first arm for pivoting the first arm about a first axis;
a second motor carried by the base unit and/or the first arm, the second motor operably coupled to the second arm for rotating the second arm about a second axis along the first arm spaced apart from the first axis;
an end-effector rotatably coupled to the second arm; and
a third motor carried by the base unit and/or the first arm, the third motor operably coupled to the end-effector for rotating the end-effector about a third axis along the second arm spaced apart from the second axis.

20. The transfer device of claim 19 wherein:
the second arm is rotatable over 360 degrees about the second axis; and
the end-effector is rotatable over 360 degrees about the third axis.

21. The transfer device of claim 19 wherein the end-effector can rotate about the third axis independent of the rotation of the second arm about the second axis.

22. The transfer device of claim 19, further comprising:
a drive assembly for rotating the end-effector about the third axis, the drive assembly including the third motor, a first pulley in the first arm, a shaft attached to the first pulley, a first belt for transmitting motion from the third motor to the first pulley and the shaft, a second pulley in the second arm and attached to the shaft, a third pulley in the second arm and operably coupled to the end-effector, and a second belt for transmitting motion from the second pulley to the third pulley and the end-effector; and
a tensioning mechanism for adjusting the tension in the second belt.

23. A transfer device for handling microfeature workpieces within an environment of a processing machine, the transfer device comprising:
a base unit;
a first arm coupled to the base unit and pivotable about a first axis;
a second arm pivotably coupled to the first arm and rotatable about a second axis along the first arm spaced apart from the first axis;
a first drive assembly for rotating the second arm about the second axis, the first drive assembly including a first motor in the base unit and/or the first arm, a first pulley in the first arm and operably coupled to the second arm, and a first belt for transmitting motion from the first motor to the first pulley;
an end-effector pivotably coupled to the second arm and rotatable about a third axis along the second arm spaced apart from the second axis; and
a second drive assembly for rotating the end-effector about the third axis, the second drive assembly including a second motor in the base unit and/or the first arm, a second pulley in the first arm, a shaft attached to the second pulley, a second belt for transmitting motion from the second motor to the second pulley and the shaft, a third pulley in the second arm and attached to the shaft, a fourth pulley in the second arm and operably coupled to the end-effector, and a third belt for transmitting motion from the third pulley to the fourth pulley and the end-effector.

24. The transfer device of claim 23 wherein:
the second arm is rotatable over 360 degrees about the second axis; and
the end-effector is rotatable over 360 degrees about the third axis.

25. The transfer device of claim 23 wherein the end-effector can rotate about the third axis independent of the rotation of the second arm about the second axis.

26. The transfer device of claim 23, further comprising a tensioning mechanism for adjusting the tension in the third belt.

27. A transfer device for handling microfeature workpieces within an environment of a processing machine, the transfer device comprising:
a base unit;
a first arm coupled to the base unit and pivotable about a first axis;
a second arm pivotably coupled to the first arm and rotatable about a second axis along the first arm spaced apart from the first axis;
an end-effector pivotably coupled to the second arm and rotatable about a third axis along the second arm spaced apart from the second axis;
a drive assembly for rotating the end-effector about the third axis, the drive assembly including a motor in the base unit and/or the first arm, a first pulley in the first arm, a shaft attached to the first pulley, a first belt for transmitting motion from the motor to the first pulley and the shaft, a second pulley in the second arm and attached to the shaft, a third pulley in the second arm and operably coupled to the end-effector, and a second belt for transmitting motion from the second pulley to the third pulley and the end-effector; and
a tensioning mechanism in the second arm for adjusting the tension in the second belt.

28. The transfer device of claim 27 wherein the tensioning mechanism comprises a mounting plate, a fourth pulley attached to the plate, and a fifth pulley attached to the plate, and wherein the mounting plate is selectively movable so that the fourth pulley exerts a force on the second belt in a first direction and the fifth pulley exerts a force on the second belt in a second direction generally opposite the first direction.

29. The transfer device of claim 27 wherein:
the second arm is rotatable over 360 degrees about the second axis; and
the end-effector is rotatable over 360 degrees about the third axis.

30. The transfer device of claim 27 wherein the end-effector can rotate about the third axis independent of the rotation of the second arm about the second axis.

31. A transfer device for handling microfeature workpieces within an environment of a processing machine, the transfer device comprising:
a base unit;
an arm assembly carried by the base unit, the arm assembly including a first arm attached to the base unit and a second arm attached to the first arm, the first arm being rotatable about a first axis and the second arm being rotatable about a second axis spaced apart from the first axis;
means for holding a microfeature workpiece, the means for holding being pivotably coupled to the second arm and rotatable over 360 degrees about a third axis spaced apart from the second axis; and
means for rotating the means for holding independent of the second arm.

32. A transfer device for handling microfeature workpieces within an environment of a processing machine, the transfer device comprising:
a base unit;
a first arm coupled to the base unit and pivotable about a first axis;
a second arm pivotably coupled to the first arm and rotatable about a second axis spaced apart from the first axis;
an end-effector pivotably coupled to the second arm and rotatable about a third axis spaced apart from the second axis; and
drive means for rotating the end-effector about the third axis without rotating the second arm about the second axis, the drive means being positioned remote from the second arm.

33. A transfer device for handling microfeature workpieces within an environment of a processing machine, the transfer device comprising:
a base unit;
a first arm coupled to the base unit and pivotable about a first axis;
a second arm pivotably coupled to the first arm and rotatable about a second axis spaced apart from the first axis;
an end-effector pivotably coupled to the second arm and rotatable about a third axis spaced apart from the second axis;
a drive assembly for rotating the end-effector about the third axis, the drive assembly including a motor in the base unit and/or the first arm, a first pulley in the first arm, a shaft attached to the first pulley, a first belt for transmitting motion from the motor to the first pulley and the shaft, a second pulley in the second arm and attached to the shaft, a third pulley in the second arm and operably coupled to the end-effector, and a second belt for transmitting motion from the second pulley to the third pulley and the end-effector; and
means for selectively adjusting the tension in the second belt.

34. A method for processing microfeature workpieces in a processing apparatus, the method comprising:
holding a workpiece with a transfer device having a base unit, a first arm coupled to the base unit and rotatable about a first axis, a second arm coupled to the first arm and rotatable about a second axis spaced apart from the first axis, and an end-effector coupled to the second arm and rotatable about a third axis spaced apart from the second axis;
pivoting the second arm about the second axis; and
rotating the end-effector over 360 degrees about the third axis independent of the pivoting of the second arm about the second axis.

35. The method of claim 34 wherein rotating the end-effector comprises pivoting the end-effector with a motor carried by the base unit and/or the first arm.

36. The method of claim 34 wherein:
pivoting the second arm comprises rotating the second arm with a first motor carried by the base unit and/or the first arm; and
rotating the end-effector comprises pivoting the end-effector with a second motor carried by the base unit and/or the first arm.

37. The method of claim 34 wherein rotating the end-effector comprises pivoting the end-effector without driving the end-effector with a motor in the second arm.

38. The method of claim 34 wherein pivoting the second arm comprises rotating the second arm over 360 degrees about the second axis.

39. The method of claim 34, further comprising pivoting the first arm about the first axis.

40. The method of claim 34 wherein:
the transfer device further includes a drive assembly for rotating the end-effector about the third axis, the drive assembly including a motor in the base unit and/or the first arm, a first pulley in the first arm, a shaft attached to the first pulley, a first belt for transmitting motion from the motor to the first pulley and the shaft, a second pulley in the second arm and attached to the shaft, a third pulley in the second arm and operably coupled to the end-effector, and a second belt for transmitting motion from the second pulley to the third pulley and the end-effector; and
rotating the end-effector comprises driving the end-effector with the drive assembly.

41. The method of claim 34 wherein:
the transfer device further includes (a) a drive assembly for rotating the end-effector about the third axis, the drive assembly including a motor in the base unit and/or the first arm, a first pulley in the first arm, a shaft attached to the first pulley, a first belt for transmitting motion from the motor to the first pulley and the shaft, a second pulley in the second arm and attached to the shaft, a third pulley in the second arm and operably coupled to the end-effector, and a second belt for transmitting motion from the second pulley to the third pulley and the end-effector, and (b) a tensioning mechanism in the second arm for adjusting the tension in the second belt; and
the method further comprises adjusting the tension in the second belt with the tensioning mechanism.
